(19) United States
(12) Patent Application Publication
(10) Pub. No.: US 2012/0157255 A1
(43) Pub. Date: Jun. 21, 2012

(54) INTEGRATED ELECTRIC POWERTRAIN ASSEMBLY DEVICE AND METHOD

(76) Inventor: Steven Trindade, Aliso Viejo, CA (US)

(21) Appl. No.: 13/390,509

(22) PCT Filed: Aug. 19, 2010
(86) PCT No.: PCT/US10/02308

§ 371 Date: Mar. 7, 2012

Related U.S. Application Data
(60) Provisional application No. 61/235,303, filed on Aug. 19, 2009.

(51) Int. Cl. F16H 37/08

(52) U.S. Cl. 475/150

(57) ABSTRACT

An integrated powertrain assembly, comprising, in combination: an electric motor having a hollow motor shaft extending along the axis of the motor; a continuously variable transmission disposed adjacent to the motor and having a hollow CVT shaft; a differential, and a pair of output shafts extending from the differential through the hollow motor shaft and the hollow CVT shaft; wherein the electric motor, the continuously variable transmission, and the differential are axially aligned along a common axis, is disclosed.

### RELATED APPLICATION

This application claims the full Paris Convention Priority from U.S. Provisional Patent Application No. 61/235,303, filed on Aug. 19, 2009, and is a U.S. National Stage entry of PCT/US2010/002308 filed Aug. 19, 2010; each as if fully set forth herein in its entirety.

### BACKGROUND

This disclosure relates to improved electric powertrain assemblies. In particular, this disclosure relates to an integrated motor, continuously variable transmission, and differential assembly with improved efficiencies and packaging characteristics.

### SUMMARY

According to embodiments, disclosed herein is an integrated powertrain assembly, comprising, in combination: an electric motor having a hollow motor shaft extending along the axis of the motor; a continuously variable transmission disposed adjacent to the motor and having a hollow CVT shaft; a differential, and a pair of output shafts extending from the differential through the hollow motor shaft and the hollow CVT shaft; wherein the electric motor, the continuously variable transmission, and the differential are axially aligned along a common axis.

The continuously variable transmission may comprise a CVT input assembly and a CVT output assembly. The continuously variable transmission may be a single-cavity, axially aligned toroidal continuously variable transmission. The CVT input assembly may connect to a motor output assembly. The CVT input assembly may be axially connected in series to the motor output assembly. The CVT output assembly may be axially connected in series to a differential input assembly. The CVT output assembly may connect to the output shaft via the differential. The continuously variable transmission may be disposed between the motor and the differential. Each of the output shafts may be configured to transfer power to a wheel. The output shafts may connect to wheels via corresponding constant-velocity joints. The motor may be an electric motor. The integrated powertrain assembly may be scaleable.

According to embodiments, disclosed herein is a powertrain system, comprising, in combination: an electric motor having a hollow motor shaft extending along the axis of the motor; a continuously variable transmission disposed adjacent to the motor and having a hollow CVT shaft; a differential; a pair of output shafts extending from the differential through the hollow motor shaft and the hollow CVT shaft; wherein the electric motor, the continuously variable transmission, and the differential are axially aligned along a common axis; a battery; a motor controller and power converter adapted to control the motor and transfer power from the battery; a CVT controller adapted to manage the transmission ratio from a CVT input assembly to a CVT output assembly; and an integrated powertrain controller adapted to manage commands and information from the driver and at least one sensed condition.

According to embodiments, disclosed herein is a method of operating an integrated powertrain assembly, comprising, in combination: transferring power produced by an electric motor from a motor output to a CVT input along an axis; converting the power received by the CVT input to a power of a CVT output, wherein the CVT input and the CVT output are components of a continuously variable transmission aligned along the axis; transferring the power of the CVT output to a differential input along the axis; and transmitting the power received by the differential input to a set of output shafts aligned along the axis with one extending through the CVT and the motor and the other extending out the opposite side.

### DRAWINGS

The above-mentioned features and objects of the present disclosure will become more apparent with reference to the following description taken in conjunction with the accompanying drawings wherein like reference numerals denote like elements and in which:

FIG. 1 shows a block diagram of an integrated powertrain assembly and control system, according to embodiments of the present disclosure;

FIG. 2A shows a block diagram of an integrated powertrain assembly, according to embodiments of the present disclosure;

FIG. 2B shows a cross-sectional view of an integrated powertrain assembly, according to embodiments of the present disclosure;

FIG. 3 shows a view of a double-cavity toroidal CVT, according to embodiments of the present disclosure;

FIG. 4A shows a cross-sectional view of a double-cavity toroidal CVT, according to embodiments of the present disclosure;

FIG. 4B shows a cross-sectional view of a double-cavity toroidal CVT, according to embodiments of the present disclosure;

FIG. 5A shows a cross-sectional view of a single-cavity toroidal CVT, according to embodiments of the present disclosure;

FIG. 5B shows a cross-sectional view of a single-cavity toroidal CVT, according to embodiments of the present disclosure;

FIG. 6 shows a table comparing results of a comparison study, according to embodiments of the present disclosure;

FIG. 7 shows a block diagram of a centrally-located integrated powertrain assembly, according to embodiments of the present disclosure; and

FIG. 8 shows a block diagram of a “T”-configuration for an integrated powertrain assembly, according to embodiments of the present disclosure.

### DETAILED DESCRIPTION

According to embodiments, a powertrain assembly is disclosed, comprising a motor, a continuously variable transmission (“CVT”), and a differential that are axially aligned. For example, an axis of each component may align along a common axis shared by all three components. The axial alignment of these three components to interface in an efficient manner. According to embodiments, an output shaft may be provided along the common axis, such that the motor, the CVT, and the differential may be configured in series along the common axis. According to embodiments, a hollow motor shaft may be provided for the output shaft to pass through the motor. A hollow CVT shaft may also be provided for the output shaft to pass through the CVT.

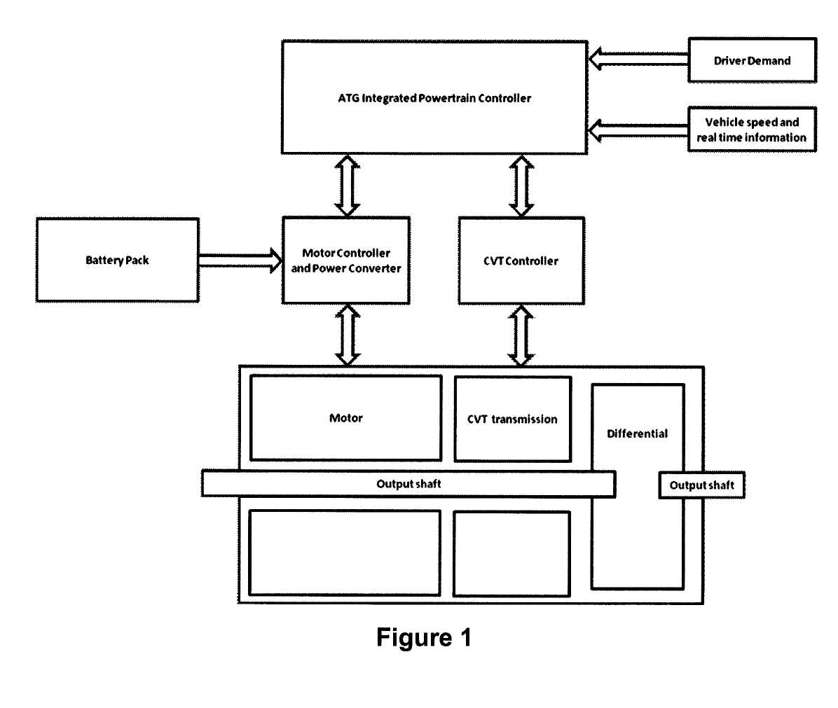

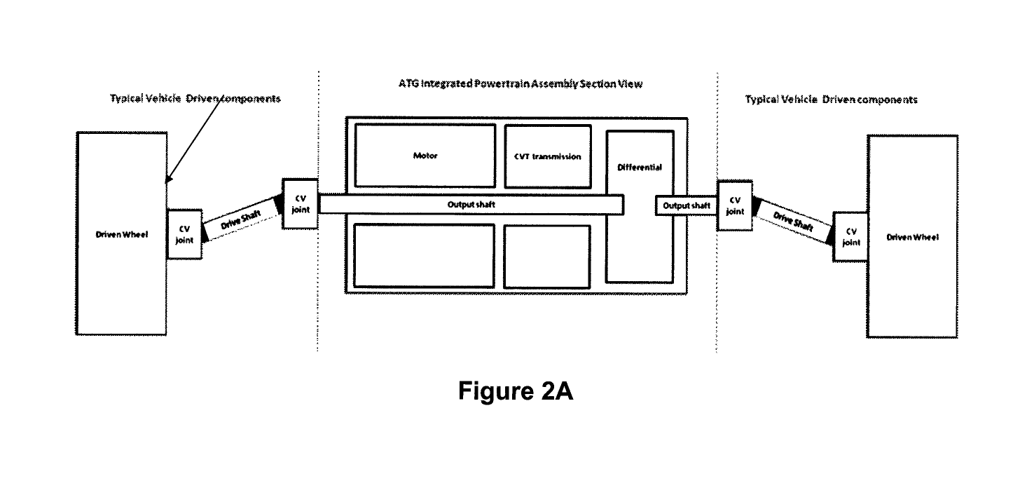

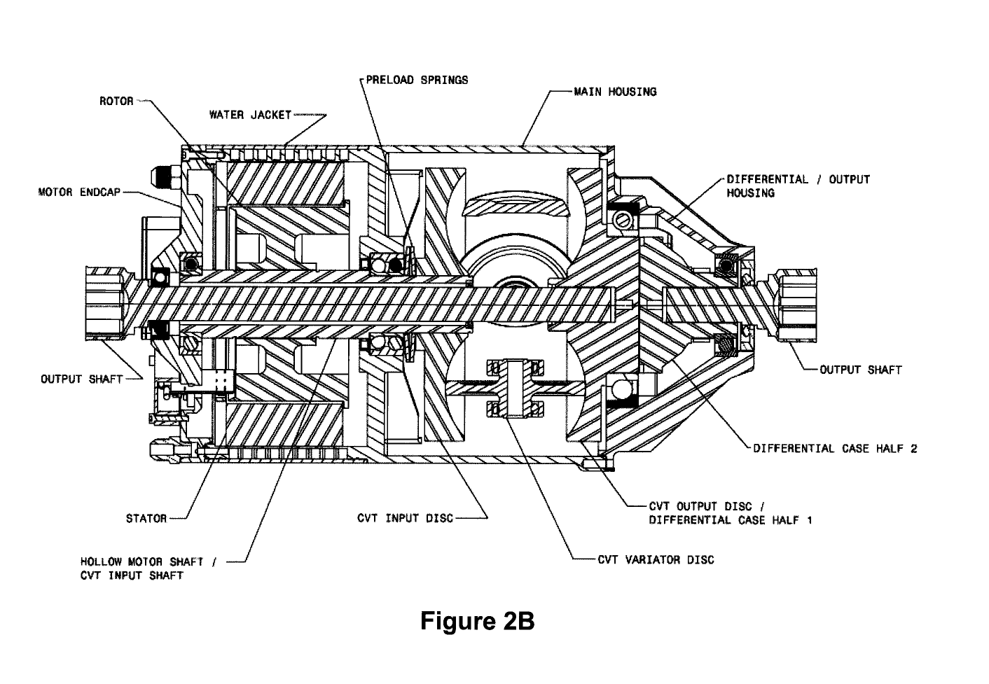

Reference is made to FIGS. 1 and 2A, which show block diagrams of an integrated powertrain assembly and control system, according to embodiments of the present disclosure. Further reference is made to FIG. 2B, which show cross-sectional views of an integrated powertrain assembly, according to embodiments of the present disclosure.

According to embodiments, the motor includes a stator, a rotor, and a motor output assembly (or hollow motor shaft) configured to connect to and transfer rotational power to a CVT input assembly (or CVT input shaft or flange). According to embodiments, the motor may be any one of an electric motor, a hybrid electric, a fuel cell powered motor, or another type of motor.

According to embodiments, the CVT includes a CVT input assembly to connect to and receive power from the motor and a CVT output assembly configured to connect to and transfer power to the differential.

According to embodiments, the motor, the CVT, and the differential may be aligned in series along a common axis. According to embodiments, various configurations may be achieved. For example, the CVT may be disposed adjacent to the motor.

According to embodiments, the motor output assembly may provide power to the CVT input assembly. According to embodiments, the CVT output assembly may provide power to the differential disposed along the common axis. The differential may be configured to transfer the power from the CVT to the output shaft(s).

The output shaft(s) may extend in either direction along the common axis from the differential. In the direction of the motor, the output shaft may extend through the hollow motor shaft (along the common axis) of the motor. In the direction of the CVT, the output shaft may extend through the hollow CVT shaft (along the common axis) of the CVT.

According to embodiments, an axial (series) connection between the motor output assembly and the CVT input assembly may be provided (e.g., a motor-CVT interface). Such a configuration avoids the need for a parallel connection between the motor and the CVT. Where both the motor is axially connected to the CVT and the output shaft extends through the axis of the motor (through the hollow motor shaft), then the motor-CVT interface may be co-axial with the output shaft. Such a configuration could be achieved with the output shaft disposed within the motor-CVT interface and extending there through.

According to embodiments, the CVT may be any one of a toroidal CVT, a variable-diameter pulley (VDP), an infinitely variable transmission, a ratcheting CVT, a hydrostatic CVT, a variable toothed wheel transmission, a cone CVT, a radial roller CVT, a traction-drive CVT, or any other continuously variable transmission device. Control systems for the CVT may be of any type, including hydraulic actuation, electric servo, or mechanical potential energy systems (e.g., springs).

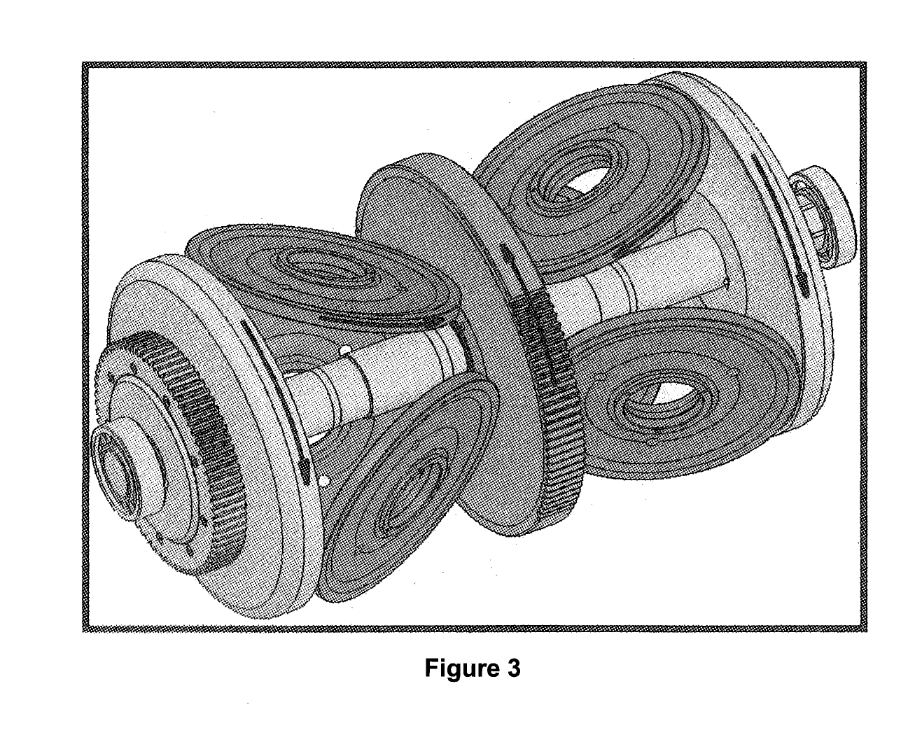

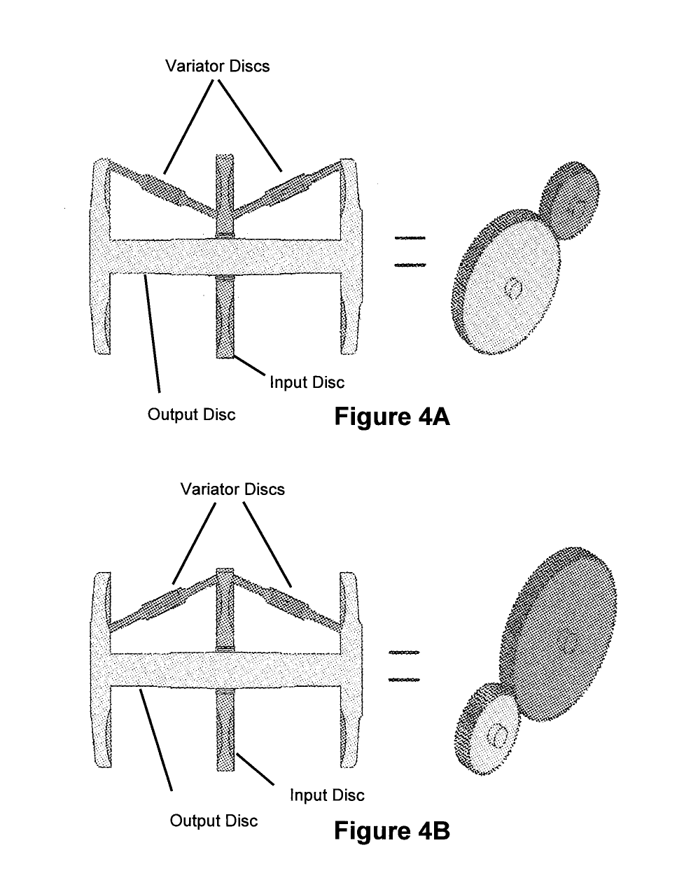

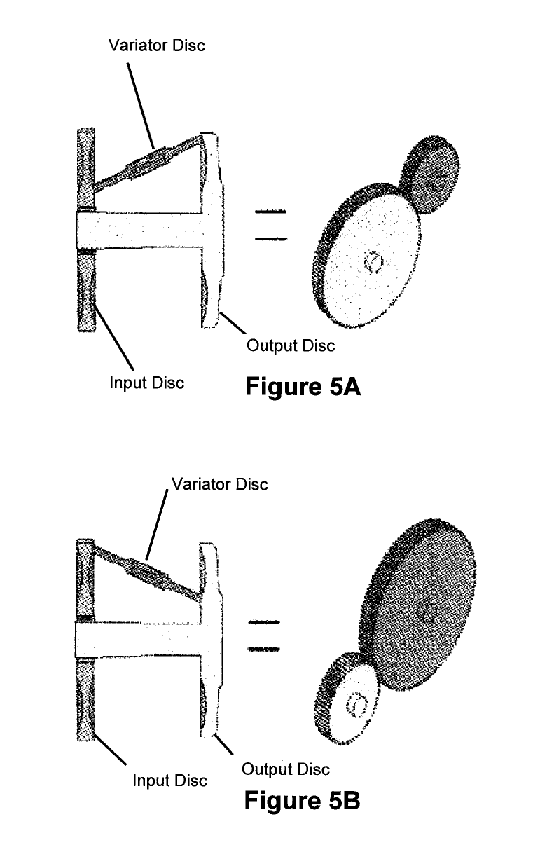

According to embodiments, the CVT may be a toroidal CVT with either a single cavity or double cavity. An example of a double-cavity toroidal CVT is provided in FIGS. 3, 4A, and 4B. An example of a single-cavity toroidal CVT is provided in FIGS. 5A-5B. The CVT output assembly of the toroidal CVT may extend through the axis of the CVT input assembly and connect to a differential input assembly. Where a single-cavity toroidal CVT is used, the motor output assembly may be axially connected (in series) to the CVT input assembly.

According to embodiments, the traction (or variator) disc(s) of a single-cavity toroidal CVT may provide a force between the CVT input assembly and the CVT output assembly, resulting in a side load. This side load may be translated to one or both of the motor output assembly and the differential input assembly. As shown in FIG. 2B, at least one set of preload springs may be provided at the interface between the CVT and the motor.

According to embodiments, a differential may be provided on one side of the motor and CVT portion of the powertrain assembly. According to embodiments, the CVT output assembly may connect to the differential input assembly. In turn, the output assemblies of the differential may connect to the output shaft extending in both directions on either side of the differential along the common axis. According to embodiments, a variety of differentials may be used. For example, the differential may be any one or more of an Open differential, Spool, Detroit Locker, Cam and Pawl, Salisbury (Newland Powerflow), and Automatic Torque Biasing differentials, inter alia. The differential may be used with passive or active (e.g., advanced, computer-based, etc.) controls.

According to embodiments, where the differential is aligned co-axially with the output shaft, the differential may obviate the need for a traditional ring gear interface configuration to translate rotational motion about one axis (i.e., rotation of a pinion or other output of a transmission) to rotational motion of the ring gear about a different axis (i.e., rotation of the ring gear of the differential). For example, the CVT output assembly may connect axially (in series) and directly to the input assembly of the differential (such as the outer rotating case of an open differential). By further example, at least a portion of the CVT output assembly may provide the structure for the outer rotating case of an open differential, as shown in FIG. 2B. No interface (rack and pinion, etc.) is required in such a configuration; rather, the CVT output assembly may be directly and fixedly attached to the differential input assembly, such that a 1:1 rotational ratio is fixed between the CVT output assembly and the differential input assembly.

According to embodiments, a single speed reduction device may be included to provide customized operating range adjustments in conjunction with the CVT. For example, the natural gear ratios between the motor and the CVT, the CVT and the differential, or the differential and the output shaft may be altered by a single speed reduction device to shift the range of operating relationships.

According to embodiments, a parking pawl is integrated into the CVT to provide a traditional “Park” setting in the transmission.

According to embodiments, the motor is water-cooled, with the transmission and differential utilizing a separate oil cooling system.

According to embodiments, the powertrain assembly is mountable on a vehicle approximately between the driven wheels. According to embodiments, the output shaft of the powertrain assembly may transfer power to one or a pair of wheels via a drive shaft. The drive shafts may connect the output shaft to the wheels by at least one constant-velocity joint.

According to embodiments, axial alignment allows for compact package which allows for placement of the assembly between the driven wheels of a vehicle.

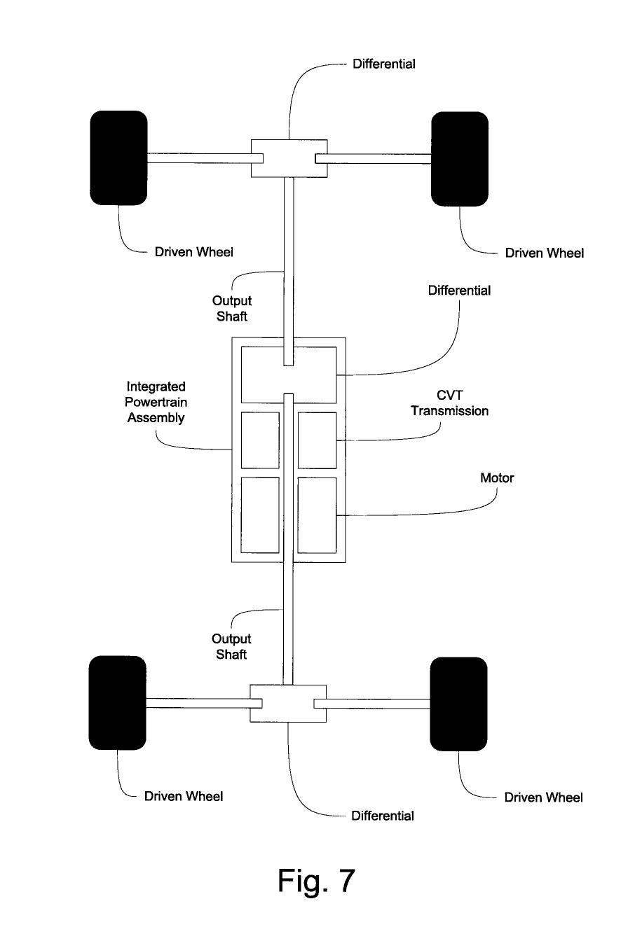

According to embodiments, other placements of the assembly are contemplated and within the present disclosure. According to embodiments, as shown in FIG. 7, an integrated powertrain assembly may be located between two pairs of driven wheels, such that the assembly provides power to all four wheels. For example, the assembly may be oriented parallel to the longitudinal axis of a vehicle and perpendicular to pairs of drive shafts located between pairs of wheels. Two output shafts may extend from the integrated powertrain assembly to a front and rear differential, respectively, with each of the front and rear differentials disposed between a pair of driven wheels. Appropriate interfaces between the output shafts, the differentials, and the driven wheels may be provided.

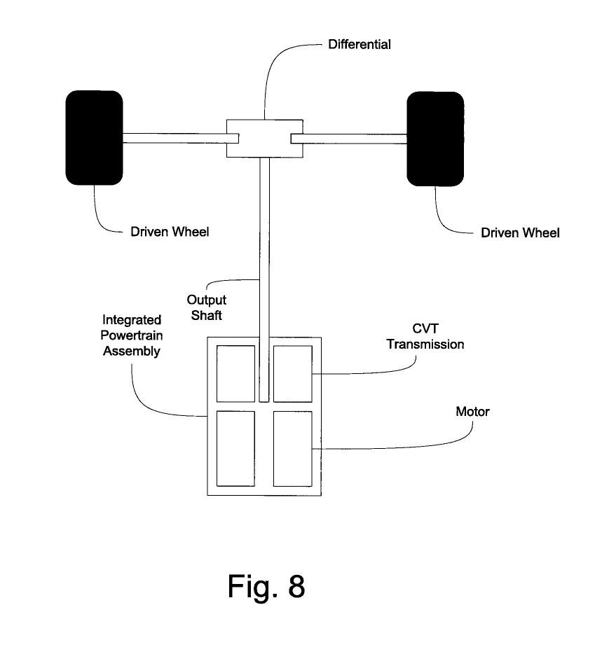

According to embodiments, as shown in FIG. 8, a powertrain assembly may be placed in a “T”-configuration with respect to a differential disposed between a pair of driven wheels. For example, an output shaft extending from the assembly may be perpendicular to a differential and a pair of drive shafts extending from the differential to the driven wheels. According to embodiments, where only one output shaft extends from the assembly, a differential may be omitted from the integrated portion of the assembly. Appropriate interfaces between the output shaft, the differential, and the driven wheels may be provided. The “T”-configuration shown in FIG. 8 and disclosed herein may be employed, for example, where the distance between the two driven wheels prevents an integrated powertrain assembly to be disposed between the wheels.

According to embodiments, a plurality of powertrain assemblies may be provided, with each powertrain assembly located approximately between a pair of driven wheels. For example, a vehicle with four wheels may be provided with two powertrain assemblies—one for each pair of driven wheels. Systems may be provided to manage the activity of each powertrain assembly relative to the other, such that optimal driving performance is achieved in a variety of environments. Multiple assemblies may be provided on vehicles having more pairs of driven wheels, according to embodiments (e.g., on a large truck with multiple driven axles such as an 18 wheeler tractor).

According to embodiments, the main housing of an integrated powertrain assembly may be used as a load bearing member, as with a solid axle rear end which is currently in use.

According to embodiments, control and sensing systems may be provided to interact with and manage the powertrain assembly. For example, as shown in FIG. 1, a motor controller and power converter may be provided to control the motor. Adequate power may be provided by a battery pack, which may be managed by the motor controller and power converter. By way of further example, a CVT controller may be provided to manage the transmission ratio from the CVT input assembly to the CVT output assembly.

According to embodiments, as shown in FIG. 1, an integrated powertrain controller may be provided to manage commands and information from the driver and sensed conditions. The driver demands may determine the amount of torque provided by the motor, initiation of regenerative braking, etc. Information regarding the speed of the vehicle and other environmental conditions may be collected and transmitted to the integrated powertrain controller for use by either the motor controller or the CVT controller.

According to embodiments, the integrated powertrain controller also manages information transmitted between the motor controller and the CVT controller. For example, information regarding the motor's RPM may be used for management of the CVT by the CVT controller.

According to embodiments, a computer control strategy may be provided for altering the system's responses to input. The system may receive driver and vehicle inputs and determine motor and transmission control outputs to meet selected criteria. For example, a driver may select one of an economy mode and a sport mode with different powertrain operating strategies depending on selection.

According to embodiments, the device of the present disclosure offers a flexible design that is scalable for different vehicle applications. A larger motor, transmission, and differential can be installed to accommodate most types of driven vehicles. The powertrain assembly disclosed is scalable from utility carts, golf carts, fork trucks, and small automobiles, to light trucks, commercial vehicles such as delivery vehicles, tractor trailers and busses and even trains, cranes, aircraft and conveyor systems.

According to embodiments, the components of the powertrain assembly disclosed herein may be “integrated.” Integration into a single assembly facilitates simple interchangeability of the assembly and application into existing or new systems. For example, according to embodiments, the components of the powertrain assembly are axially aligned to provide dual output shafts along an axis, such that the powertrain assembly is operable as it is disposed between or near the driven wheels. According to embodiments, accommodation for the powertrain assembly disclosed herein my only require providing a space for installation between the driven wheels, connection thereto, and connection to control equipment. An integrated package eliminates need for new vehicle manufacturers to expend resources developing a new powertrain and enables the introduction of new electric and hybrid vehicles.

According to embodiments, an integrated and axially aligned package allows for extremely compact assembly. Such a compact package is easily installed into existing vehicles or new vehicles. The single and common axis reduces vehicle complexity and weight, and provides efficiencies through fewer transitions between parts.

According to embodiments, a powertrain assembly as disclosed herein may increase overall drive train efficiency over the entire drive cycle due to the use of a transmission as disclosed herein. Furthermore, a powertrain assembly as disclosed herein may provide increased drivability and performance through the use of a transmission to optimize power output.

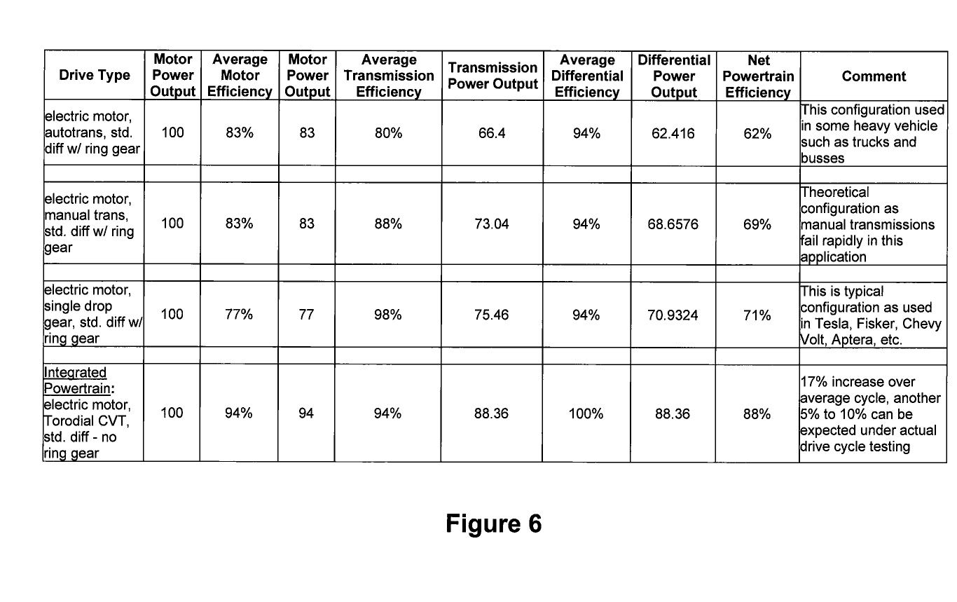

For example, studies were conducted comparing four drive types: (1) an electric motor, automatic transmission, and standard differential with a ring gear; (2) an electric motor, manual transmission, and standard differential with a ring gear; (3) an electric motor, single drop gear, and standard differential with a ring gear; and (4) an integrated powertrain including an electric motor, a toroidal CVT, and standard differential with no ring gear. The results of the study are presented in the table of FIG. 6. Of the four configurations, the integrated powertrain obtained the most favorable average motor efficiency, motor power output, transmission power output, average differential efficiency, differential power output, and net powertrain efficiency. The average transmission efficiency was also more favorable than configurations (1) and (2) and almost as favorable as configuration (3). Notably, the net powertrain efficiency was 88%—significantly exceeding the next highest efficiency, 71%.

According to embodiments, a powertrain assembly may be configured to provide increased regenerative braking efficiency by rapidly changing the transmission ratio to the optimum settings for recharging during a braking event. Corresponding control systems may be provided and configured to sense and respond to such conditions to provide regenerative braking.

According to embodiments, a method of operating a device and system is disclosed herein. According to embodiments, an electric motor, for example, may produce rotational power provided by a motor output rotating about an axis.

According to embodiments, the power produced by an electric motor may be transferred from a motor output to a CVT input along an axis. The power received by the CVT input may be transmitted to a CVT output producing a power of the CVT output. The CVT input and the CVT output may be components of a continuously variable transmission aligned along the axis.

According to embodiments, the power of the CVT output may be transferred to a differential input along the axis. The power received by the differential input may be transmitted to an output shaft having two extensions aligned along the axis and extending in either direction from the differential. In one direction, an extension of the output shaft may pass through the CVT and the motor while the other extends directly out the opposite side.

The appendix provided herewith is hereby incorporated by reference into the body of the present disclosure, as if fully set forth herein.

While the method and agent have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all references listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. An integrated powertrain assembly, comprising, in combination:
an electric motor having a hollow motor shaft extending along a common axis;
a continuously variable transmission disposed adjacent to the motor;
a differential connected to the continuously variable transmission, and
a first output shaft and a second output shaft extending in opposite directions from the differential along the hollow motor shaft, the motor, and the continuously variable transmission;
wherein the motor, the continuously variable transmission, and the differential are axially aligned along the common axis.

2. The integrated powertrain assembly of claim 1, further comprising a gear assembly, wherein the differential is connected to the continuously variable transmission via the gear assembly.

3. The integrated powertrain assembly of claim 2, wherein the gear assembly is disposed between the differential and the continuously variable transmission; wherein the gear assembly is aligned along the common axis; and wherein the first output shaft extends through the gear assembly.

4. The integrated powertrain assembly of claim 1, wherein the continuously variable transmission comprises a CVT input assembly and a CVT output assembly.

5. The integrated powertrain assembly of claim 1, wherein the continuously variable transmission is an axially aligned toroidal continuously variable transmission assembly.

6. The integrated powertrain assembly of claim 4, wherein the CVT input assembly is axially connected in series to the hollow motor shaft.

7. The integrated powertrain assembly of claim 4, wherein the CVT output assembly is axially connected in series to a differential input assembly.

8. The integrated powertrain assembly of claim 4, wherein the CVT output assembly connects to the output shafts via the differential.

9. The integrated powertrain assembly of claim 1, wherein the continuously variable transmission is disposed along the common axis between the motor and the differential.

10. The integrated powertrain assembly of claim 1, wherein the motor, the continuously variable transmission, and the differential are housed within a main housing disposed between a pair of driven wheels.

11. A powertrain system, comprising, in combination:
a motor having a hollow motor shaft extending along the axis of the motor;
a continuously variable transmission disposed adjacent to the motor;
a differential;
a first output shaft and a second output shaft extending in opposite directions from the differential along the common axis, the first output shaft through the hollow motor shaft, the motor, and the continuously variable transmission;
wherein the motor, the continuously variable transmission, and the differential are axially aligned along a common axis;
a power source;
a motor controller and power converter adapted to control the motor and transfer power from the power source;
a CVT controller adapted to manage the transmission ratio from a CVT input assembly to a CVT output assembly; and
a powertrain controller adapted to receive and manage driver demands and vehicle input containing at least one sensed condition.

12. The powertrain system of claim 11, further comprising a gear assembly, wherein the differential is connected to the continuously variable transmission via the gear assembly; wherein the gear assembly is disposed between the differential and the continuously variable transmission; wherein the gear assembly is aligned along the common axis; and wherein the first output shaft extends through the gear assembly.

13. The powertrain system of claim 11, wherein each of the first output shaft and second output shaft is configured to transfer power to a wheel.

14. The powertrain system of claim 11, wherein each of the first output shaft and second output shaft is configured to transfer power to a downline differential having a plurality of drive shafts.

15. A method of operating an integrated powertrain assembly, comprising, in combination:
transferring an input power produced by a motor from a motor shaft to a CVT input along a common axis;
converting the input power received by the CVT input to a CVT output power of a CVT output according to a transmission ratio, wherein the CVT input and the CVT output are components of a continuously variable transmission aligned along the axis;
transferring the CVT output power to a differential input along the common axis; and,
transmitting a first portion of the CVT output power received by the differential input to a first output shaft aligned along the common axis and extending through the CVT and the motor and a second portion of the CVT output power to a second output shaft extending along the common axis away from the CVT and the motor.

16. The method of claim 15, further comprising:
transferring the output power received by each of the first output shaft and the second output shaft to a corresponding driven wheel.

17. The method of claim 16, wherein the output power is transferred to each of the first output shaft and the second output shaft and the corresponding driven wheel via a downline differential.

18. The method of claim 15, wherein transferring the CVT output power to a differential comprises: modifying the CVT output power via a gear assembly.

19. The method of claim 15, further comprising:
modifying the transmission ratio based on at least one of driver demand and vehicle output.

20. The method of claim 15, further comprising:
modifying the input power produced by the motor based on at least one of driver demand and vehicle output.
